(19) United States
(12) Patent Application Publication
(10) Pub. No.: US 2011/0157622 A1
(43) Pub. Date: Jun. 30, 2011

(54) DATA DOWNLOADING AND TRANSFERRING METHOD OF E-BOOK READING APPARATUS AND SYSTEM THEREOF

(75) Inventors: TZU-LUNG CHUANG, TAIPEI COUNTY (TW); CHUAN-WEI LEE, TAIPEI COUNTY (TW); I-MEI HSU, TAIPEI COUNTY (TW)

(73) Assignee: ACER INCORPORATED, TAIPEI COUNTY (TW)

(21) Appl. No.: 12/770,747

(22) Filed: Apr. 30, 2010

(30) Foreign Application Priority Data
Dec. 31, 2009 (TW) 098146382

(51) Int. Cl. G06F 3/12

(52) U.S. Cl. 358/1.15

(57) ABSTRACT

A data downloading method of an e-book reading apparatus, a data transferring method of the e-book reading apparatus and a system thereof are disclosed. The data downloading method comprises the steps of installing a driving module of the e-book reading apparatus on print management interface of an electronic device; connecting the e-book reading apparatus and a data transmission port of the electronic device; launching the print management interface to select the e-book reading apparatus as a printing object; and downloading a file to the e-book reading apparatus via the print management interface.

### FIELD

The exemplary embodiments of the present invention relates to a field of data downloading and transferring method of e-book reading apparatus and system thereof. More specifically, the exemplary embodiments of the present invention relates to transferring data to the e-book reading apparatus through a print management interface.

### BACKGROUND

As the environmental consciousness is awaken and prevalent in these days, how to reduce the office paper consumption has become an important issue. Nowadays, the data digitization process and the system networking have effectively reduced the paper consumption. However, some users are used to read paper documents instead of reading on the screen, so the digital data would be printed out. In other occasion, the data would be printed out for using in the meeting, but those paper documents would be abandoned after the meeting so as to cause wastes. It is therefore believed that a need exists in the art for keeping user's printing habit and for reducing paper consumption.

### SUMMARY

In spite of the drawbacks of the aforementioned prior art, an object of the present invention is providing a data downloading and a transferring method of e-book reading apparatus and a system thereof. The present invention can maintain the user's habit to print out the data and transfer the file to the e-book reading apparatus.

According to an object of the present invention, a transferring method of e-book reading apparatus is rendered and comprises the following steps. First, a print management interface in an operating system is actuated in a file. The e-book reading apparatus then is selected as a printing object from a plurality of available devices. Lastly, the file is transferred to the e-book reading apparatus through the print management interface.

Also, the step of actuating a print management interface may further comprise the step of opening the file by an application, and the step of triggering a printing unit of the application to actuate the print management interface.

Besides, the step of actuating a print management interface may further comprise a step of actuating the print management interface directly through a user interface or a curser operating interface of the operating system.

Further, the data transferring method of e-book reading apparatus in accordance with the present invention may further comprise the step of determining if a first file format is compatible with the e-book reading apparatus. If not, the file format will be converted into a second file format and the converted file format will be transferred to the e-book reading apparatus.

Moreover, the data transferring method of e-book reading apparatus in accordance with the present invention may further comprise the step of rearranging contents of the file.

In addition, the data transferring method of e-book reading apparatus in accordance with the present invention may further comprise the step of displaying received contents of the file on the e-book reading apparatus during the transmission process.

Moreover, the e-book reading apparatus displays contents on each page of the file on the e-book reading apparatus in sequence for simulating a print action.

According to another object of the present invention, a computer readable storage medium storing a computer program is provided. The computer program may be downloaded to a computer system and the computer system may execute a driving method, wherein the computer system is electronically connected to an e-book reading apparatus. The driving method comprises the following steps: installing a driving module to a print management interface on the computer system; selecting the e-book reading apparatus as a printing object on the print management interface; receiving a file data by the driving module when the e-book reading apparatus is selected as a print object on the print management interface, and when the computer system process a print action; and transferring the file data to the e-book reading apparatus by using the driving module.

In certain circumstance, the driving method may further comprise the step of determining if the file format is compatible with the e-book reading apparatus. If not, the file format will be converted and the converted file format will be transferred to the e-book reading apparatus.

Also, the driving method may further comprise the step of rearranging contents of the file.

The aforementioned data downloading and transferring method of e-book reading apparatus and system thereof comprise the following advantages.

The data downloading and transferring method of e-book reading apparatus and system thereof can download the data to the e-book reading apparatus conventionally and thus reduce the paper consumption.

With these and other objects, advantages, and features of the invention that may become hereinafter apparent, the nature of the invention may be more clearly understood by reference to the detailed description of the invention, the embodiments and to the several drawings herein.

### BRIEF DESCRIPTION OF THE DRAWINGS

The exemplary embodiments of the present invention will be understood more fully from the detailed description given below and from the accompanying drawings of various embodiments of the invention, which, however, should not be taken to limit the invention to the specific embodiments, but are for explanation and understanding only.

FIG. 1 illustrates a block diagram of an electronic system in accordance with an embodiment of the present invention;

FIG. 2 illustrates a schematic view of a file actuating a print management interface in accordance with the present invention;

FIG. 3 is a schematic view illustrating an example of a print management interface in accordance with an embodiment of the present invention;

FIG. 4 is a block diagram illustrating a driving module in accordance with the present invention;

FIG. 5 is a flow chart illustrating a transferring method of e-book reading apparatus in accordance with the present invention;

FIG. 6 is a flow chart illustrating a transferring method of e-book reading apparatus in accordance with the first embodiment of the present invention; and

FIG. 7 is a flow chart illustrating a transferring method of e-book reading apparatus in accordance with the second embodiment of the present invention.

### DETAILED DESCRIPTION

Exemplary embodiments of the present invention are described herein in the context of a data downloading and a transferring method of e-book reading apparatus and a system thereof.

Those of ordinary skilled in the art will realize that the following detailed description of the exemplary embodiments is illustrative only and is not intended to be in any way limiting. Other embodiments will readily suggest themselves to such skilled persons having the benefit of this disclosure. Reference will now be made in detail to implementations of the exemplary embodiments as illustrated in the accompanying drawings.

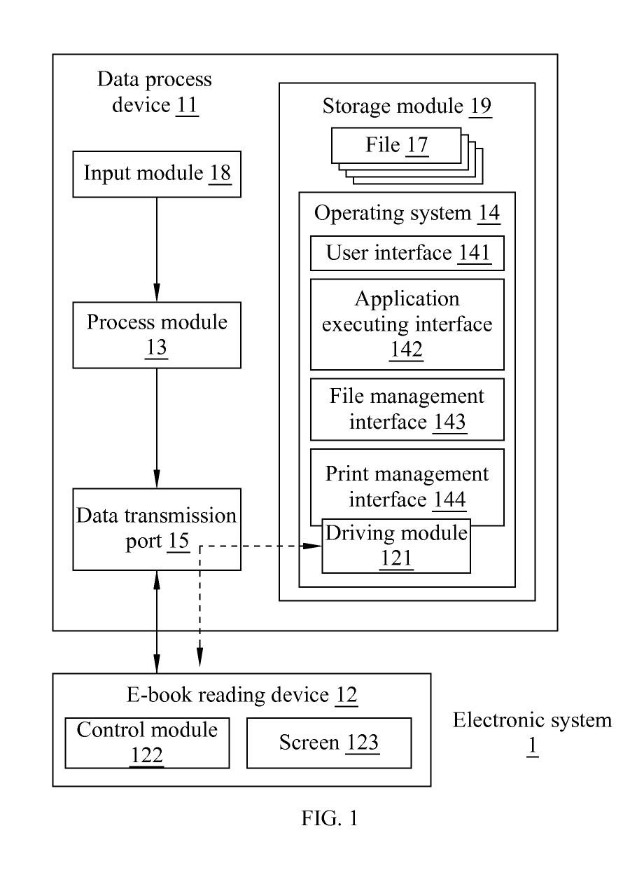

Please refer to FIG. 1, which illustrates a block diagram of an electronic system in accordance with an embodiment of the present invention. As shown, the electronic system 1 comprises a data process device 11 and an e-book reading apparatus 12. The data process device 11 comprises a process module 13, a operating system 14, a data transmission port 15, an input module 18, and a storage module 19. Also, the e-book reading apparatus 12 electrically connects to the data process device 11 through the data transmission port 15. The data process device 11 may be a desktop computer, a notebook computer, a cell phone, a personal digital assistant (PDA), or a electronic device with output printing data, and the data process 11 can be executed on a computer system. In addition, the data transmission port 15 may be a serial bus port (For example: USB), a web transmission port (For example: WLAN or Bluetooth), a wireless web transmission port (For example: 3G transmission port), or an infrared ray transmission port. Besides, the process module is preferably a processor or a microcontroller. The storage module 19 stores the operating system 14, which is able to be executed on process module 13, a plurality of files 17, and the driving module 121 of the e-book reading apparatus 12. Also, the input module 18 is preferably a mouse, a curser control device, a keyboard, or a touch device.

When the operating system 14 is executed, other application or peripherals electrically connected to the data process device 11 can utilize the software or hardware sources of the data process device 11 through the operating system 14. The operating system 14 at least generates a user interface 41, an application executing interface 142, a file management interface 143, and a print management interface 144. The user controls the data process device 11 by the user interface 141, and the data process device 11 at least comprises a keyboard control interface, a curser control interface, or a touch control interface. The application executing interface 142 provides the user to execute a specific application. The file management interface 143 provides the users with the file attribute setting, the storage location of the management file, and the access to the files. The print management interface 144 provides at least one peripheral devices for user to manage and transfer digital data to the printing device. The print management interface 144 is preferably an open interface, that is, the print management interface 144 can install driving modules of a variety of peripheral devices.

In addition, a driving module 121 corresponding to the e-book reading apparatus 12 is installed in the print management interface 144 so that the e-book reading apparatus 12 can be selected as a print object by the user. For instance, the operating system of Windows®, released by Microsoft®, is preferably a driving program, such as a function driver function compatible with the Windows Driver Module (WDM). When the e-book reading apparatus 12 is selected as a printing object and a printing a printing motion is performed, the e-book reading apparatus 12 receives a file 17 through the print management interface 144.

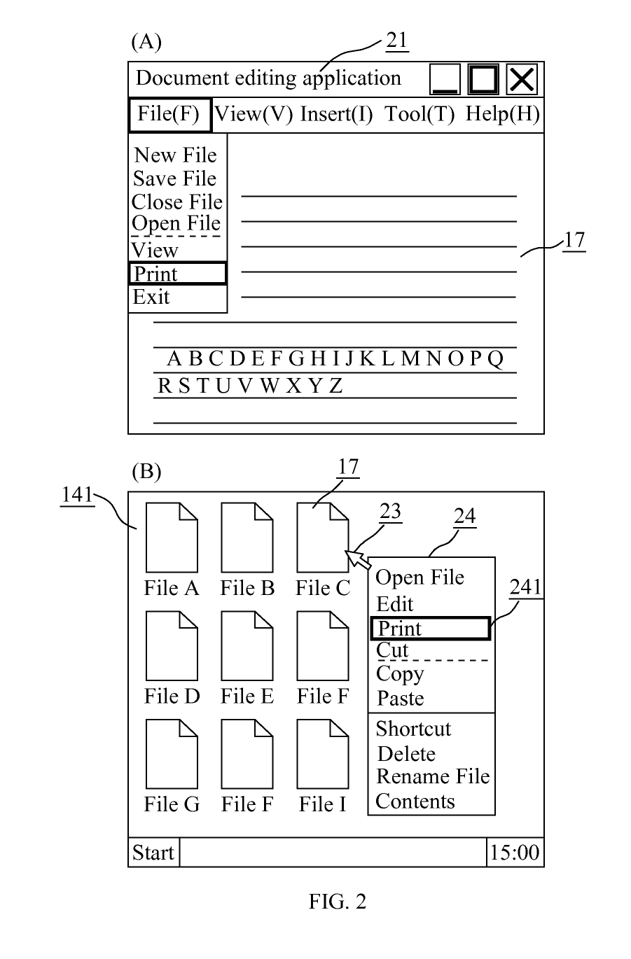

There are two actuating method of the print management interface 144. The first one is actuating the print management interface 144 through the print function of an application, and the other one is actuating the print management interface 144 through a curses control interface of the operating system. Please refer to FIG. 2, which illustrates schematic views of a file actuating a print management interface in accordance with the present invention. As shown in view (A), the user utilizes the document editing application 21 to open file 17 for reading the contents of the file 17, and to trigger a printing unit 22 of the document editing application 21 for actuating the print management interface 144. On the other hand, in view (B), the user clicks the icon on the file 17 by an input device 18 (For example: a mouse) to generate a file instruction menu 24 through a curser control interface 23 in an operating system 14. Then the user may select the print unit 241 on the file instruction menu 24 to actuate the print management interface 22 corresponding to the file 17. Besides, the aforementioned application is preferably a text processing program, an image processing program, a document reading program, a web-page browser program, an e-mail receiving/transmitting program, or an application with printing function.

Moreover, the file opened by an application is not limited to a text file, and any activity that executing an application with printing function to display specific data contents is in the scope of the present invention. For example, after executing a web browsing program and alter browsing the web contents, the user can transfer the web contents to the e-book reading apparatus 12 through the aforementioned data transferring or downloading method. On the other hand, after executing an e-mail receiving/transmitting program and reading e-mail, the user can transfer the e-mail contents to the e-book reading apparatus 12 through the aforementioned data transferring or downloading method.

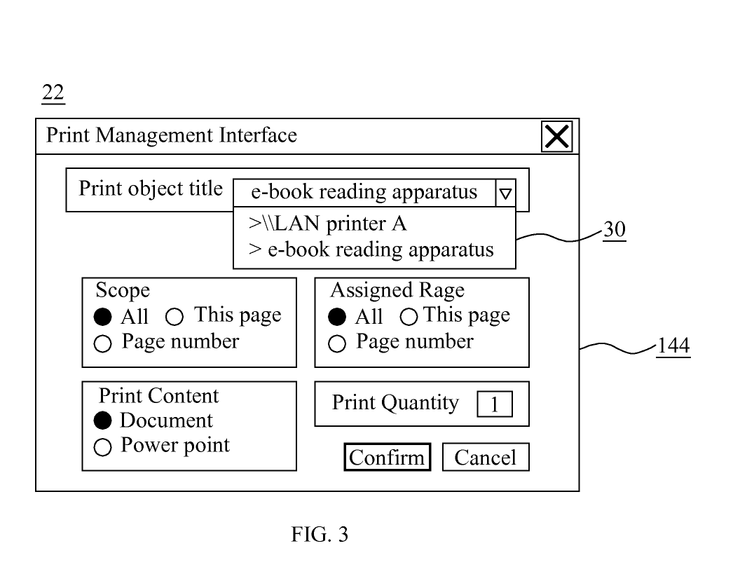

Please refer to FIG. 3, which is a schematic view illustrating an example of a print management interface in accordance with one embodiment of the present invention. As shown, the print management interface 144 comprises a printing object selecting unit 30 and other related printing units. The user can select appropriate printing object through the printing object selecting unit 30. If the driving module 121 of the e-book reading apparatus 12 is installed on the print management interface 144, the printing object selecting unit 30 displays option in responsive to the e-book reading apparatus 12. When the user selects the e-book reading apparatus 12 as a printing object and performs the printing action, the print management interface 16 outputs file 17 through the driving module 121 and the driving module 121 transfers the file 17 to the e-book reading apparatus 12 through the data transmission port 15.

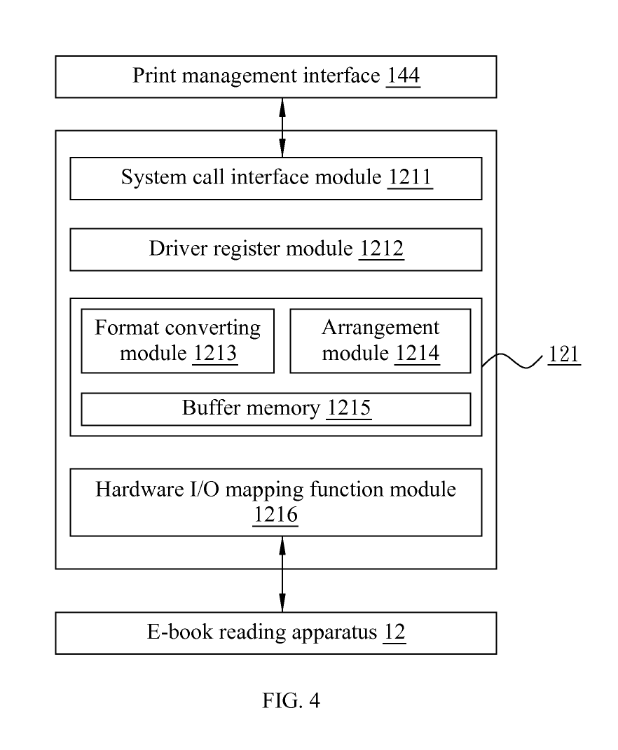

Except transferring the file to the e-book reading apparatus 12, the driving module 121 can perform other functions as desired, such as rearranging the file contents or transferring the file formats. Please refer to FIG. 4, which is a block diagram illustrating a driving module in accordance with the present invention. As shown, the driving module comprises a system call interface 1211, a driver register module 1212, a format converting module 1213, an arrangement module 1214, a buffer memory 1215, or a hardware I/O mapping function module 1216. Further, the format converting module 1213 and arrangement module 1214 are optional and may be added or omitted. The system call interface module 1211 can communicate with the print management interface 144 to transfer data. The driver register module 1212 installs the driving module 121 onto the operating system 14. The e-book reading apparatus therefore can be displayed as an available printing object when the print management interface 22 is actuated.

When the format of the file 17 is not compatible with the e-book reading apparatus, the format converting module 1213 may convert the format of the file 17. Also, the arrangement module 1214 may rearrange the layout of the file 17 according to the resolution or display characters of the screen, so as to perform better display result of the file 17 on the e-book reading apparatus. The buffer memory 1215 may temporary store the data waiting for transmission. Moreover, the hardware I/O mapping function module 1216 ensures that the hardware address of the e-book reading apparatus 12 is correct and the file 17 is transferred to the e-book reading apparatus 12 correctly.

In the aforementioned data transferring method, the control module 122 of the e-book reading apparatus 12 may display the received content of the file on the screen 123 as desired to show the user the file transmission status. If the data is transferred in sequence from the content of the first page, the e-book reading apparatus preferably displays the received contents on each page of the file in sequence for simulating a conventional print action.

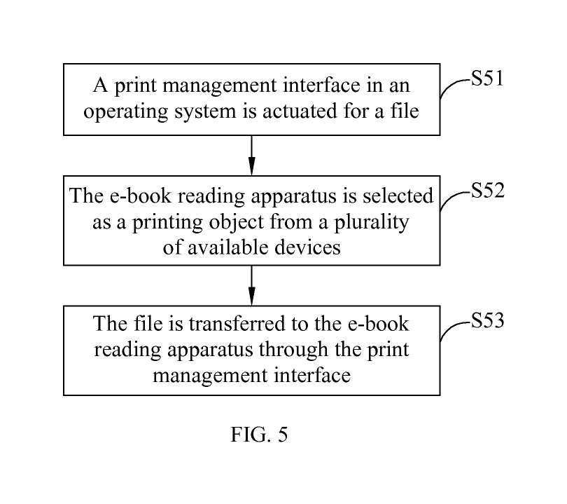

Please refer to FIG. 5, which is a flow chart illustrating a transferring method of e-book reading apparatus in accordance with the present invention. As shown, the transferring method comprises the following steps. First, in the step S51, a print management interface in an operating system is actuated in a file. In an embodiment, the method can be performed by opening a file and then actuating the print management interface through an application. On another embodiment, the print management interface is actuated directly through a curser control interface in the operating system. The print management interface is preferably an open interface, that is, the print management interface can install driving modules of a variety of peripheral devices. In the step S52, the e-book reading apparatus is selected as a printing object from a plurality of available devices on the print management apparatus. Before the step S52, the driving module of the e-book reading apparatus must be installed on the print management interface. Then in step S53, the file is transferred to the e-book reading apparatus through the print management interface.

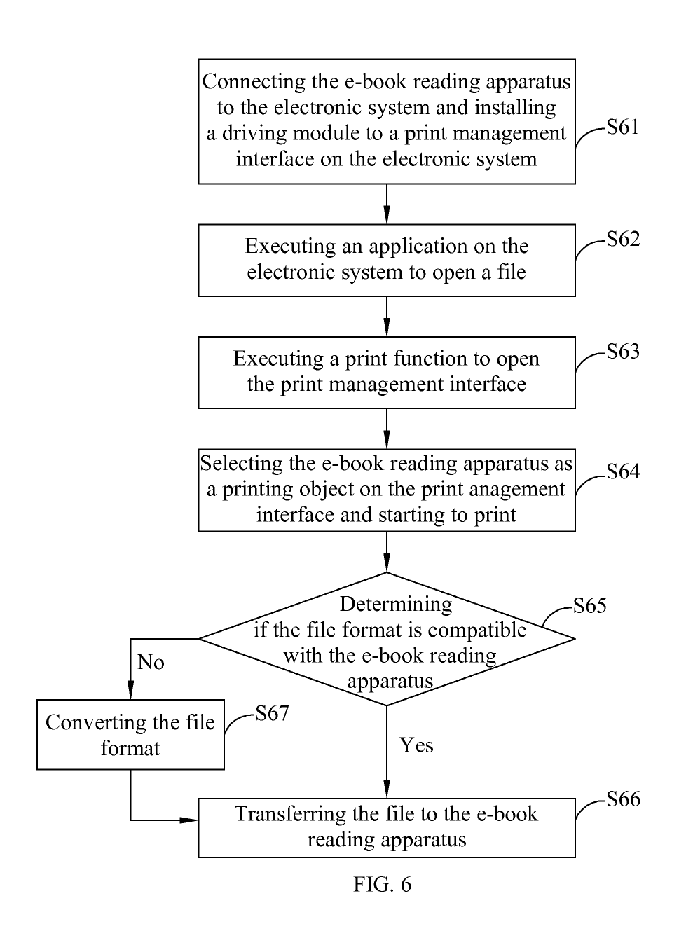

Please refer to FIG. 6, which is a flow chart illustrating a transferring method of an e-book reading apparatus in accordance with the first embodiment of the present invention. As shown, the step S61 is connecting the e-book reading apparatus to the electronic system and installing a driving module to a print management interface on the electronic system. The e-book reading apparatus therefore becomes an available printing object on the print interface of the electronic system. In the step S62, an application on the electronic system is executed to open a file stored in the electronic system. In the step S63, a print function is executed to open the print management interface. In the step S64, the e-book reading apparatus is selected as a printing object on the print management interface and a printing action is performed. Following the step S65 determines if the file format is compatible with the e-book reading apparatus. If yes, the step S66 is performed to transfer the file to the e-book reading apparatus. If no, the step S67 is performed to convert the file format, and then the step S66 is performed to transfer the converted file to the e-book reading apparatus.

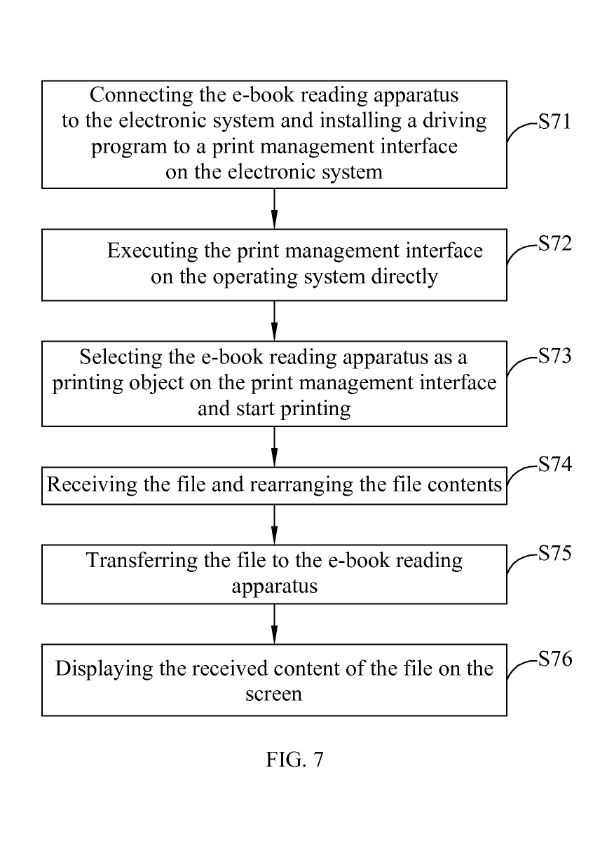

Please refer to FIG. 7, which is a flow chart illustrating a transferring method of an e-book reading apparatus in accordance with the second embodiment of the present invention. As shown, in the step S71, the e-book reading apparatus connects to the electronic system and installs a driving program to a print management interface on the electronic system. In the step S72, the print management interface is executed in the operating system directly. For instance, in the window-based operating system, a curser is operated to click an icon on the file for triggering a file instruction menu, and the print management interface is actuated through the file instruction menu, as shown in view (B) of FIG. 2.

Following in the step S73, the e-book reading apparatus is selected as a printing object on the print management interface and a printing action is performed. In the step S74, the file is received and the file contents are rearranged to achieve the most suitable display result. Moreover, the user may set the print management interface to determine if there is a need to rearrange the contents. In the step S75, the file is transferred to the e-book reading apparatus. In the step S76; the received content of the file is displayed on the screen. For example, the e-book reading apparatus displays the received contents on each page of the file in sequence for simulating a conventional print action.

By the data downloading and transferring method of e-book reading apparatus and system thereof in the present invention, the user can output the data to the e-book reading apparatus conventionally without changing the conventional printing action. Thus the paper consumption can be reduced.

While particular embodiments of the present invention have been shown and described, it will be obvious to those skilled in the art that, based upon the teachings herein, changes and modifications may be made without departing from this invention and its broader aspects. Therefore, the appended claims are intended to encompass within their scope of all such changes and modifications as are within the true spirit and scope of the exemplary embodiments of the present invention.

What is claimed is:

1. A data transferring method of e-book reading apparatus, comprising the following steps:
actuating a print management interface of an operating system in a file;
selecting the e-book reading apparatus as a printing object from a plurality of available devices; and
transferring the file to the e-book reading apparatus through the print management interface.

2. The data transferring method of e-book reading apparatus as recited in claim 1, wherein the step of actuating a print management interface further comprises steps of:
opening the file by an application; and
triggering a printing unit of the application to actuate the print management interface.

3. The data transferring method of e-book reading apparatus as recited in claim 1, wherein the step of actuating a print management interface further comprises a step of actuating the print management interface directly through a user interface of the operating system.

4. The data transferring method of e-book reading apparatus as recited in claim 1 further comprising steps of:
determining if a first file format is compatible with the e-book reading apparatus; and
if not, converting the first file format into a second file format and transferring the second file format to the e-book reading apparatus.

5. The data transferring method of e-book reading apparatus as recited in claim 2, wherein the application is a text processing program, an image processing program, a document reading program, an e-mail receiving/transmitting program, or a web-page browser program.

6. The data transferring method of e-book reading apparatus as recited in claim 1 further comprising a step of rearranging contents of the file.

7. The data transferring method of e-book reading apparatus as recited in claim 1 further comprising a step of displaying received contents of the file on the e-book reading apparatus during the transmission process.

8. The data transferring method of e-book reading apparatus as recited in claim 7 wherein the e-book reading apparatus displays contents on each page of the file in sequence for simulating a print action.

9. An electronic system comprising:
a data processing device comprising a process module, an operating system, and a data transmission port, the process module executing the operating system and generating a print management interface; and
an e-book reading apparatus electrically connecting to the data process module through the data transmission port and receiving a file through the print management interface.

10. The electronic system as recited in claim 9, wherein the data transmission port is a serial bus port, a web transmission port, a wireless web transmission port, or an infrared ray transmission port.

11. The electronic system as recited in claim 9, wherein the process module executes an application to open the file in the operating system, and the print management interface is actuated by the application.

12. The electronic system as recited in claim 11, wherein the application is a text processing program, a image processing program, a file reading program, an e-mail receiving/transmitting program, or a web-page browser program.

13. The electronic system as recited in claim 9, wherein a driving module is installed in the print management interface.

14. The electronic system as recited in claim 13, wherein the driving module determines if a first file format is compatible with the e-book reading apparatus; if not, the driving module converts the first file format into a second file format and transfers the second file format to the e-book reading apparatus.

15. The electronic system as recited in claim 13, wherein the driving module rearranges contents of the file that waits for transmission.

16. The electronic system as recited in claim 9, wherein the e-book reading apparatus displays received contents of the file thereon.

17. The electronic system as recited in claim 16, wherein the e-book reading apparatus displays contents on each page of the file on the e-book reading apparatus in sequence for simulating a print action.

18. A data downloading method of e-book reading apparatus, comprising the following steps:
installing a driving module to a print management interface on an electronic device;
connecting the e-book reading apparatus to a data transmission port of the electronic device;
actuating the print management interface;
selecting the e-book reading apparatus as a printing object from a plurality of available devices; and
transferring the file to the e-book reading apparatus through the print management interface.

19. The data downloading method of e-book reading apparatus as recited in claim 18 further comprising steps of:
determining if a first file format is compatible with the e-book reading apparatus; and
if not, converting the first file format into a second file format and transferring the second file format to the e-book reading apparatus.

20. The data downloading method of e-book reading apparatus as recited in claim 18 further comprising steps of rearranging contents of the file.

21. The data downloading method of e-book reading apparatus as recited in claim 18 further comprising steps of displaying received contents of the file on the e-book reading apparatus during the transmission process.

22. The data downloading method of e-book reading apparatus as recited in claim 21, wherein the e-book reading apparatus displays contents on each page of the file on the e-book reading apparatus in sequence for simulating a print action:

23. A computer readable storage medium storing a computer program, the computer program being downloaded to a computer system, and the computer system executing a driving method and electronically connected to an e-book reading apparatus, the driving method comprising the following steps:
installing a driving module to a print management interface on the computer system;
selecting the e-book reading apparatus as a printing object on the print management interface;
receiving a file data by the driving module when the e-book reading apparatus is selected as a printing object on the print management interface, and when the computer system process a printing action; and
transferring the file data to the e-book reading apparatus by using the driving module.

24. The computer readable storage medium as recited in claim 23, wherein the driving method further comprises the steps of:
determining if a first file format is compatible with the e-book reading apparatus; and
if not, converting the first file format into a second file format and transferring the second file format to the e-book reading apparatus.

25. The computer readable storage medium as recited in claim 23 further comprising steps of rearranging contents of the file.
